(19) United States
(12) Patent Application Publication
(10) Pub. No.: US 2026/0092448 A1
(43) Pub. Date: Apr. 2, 2026

(54) FIBER-CONFINED ELASTOMERIC ISOLATORS (FCEIS) FOR MULTI-DIRECTIONAL VIBRATION CONTROL OF STRUCTURES

(71) Applicants: Purdue Research Foundation, West Lafayette, IN (US); Indian Institute of Technology Delhi, New Delhi (IN)

(72) Inventors: Vasant Annasaheb Matsagar, New Delhi (IN); Sarranya Banerjee, New Delhi (IN); Akanshu Sharma, West Lafayette, IN (US)

(73) Assignees: Purdue Research Foundation, West Lafayette, IN (US); Indian Institute of Technology Delhi, New Delhi, DL (IN)

(21) Appl. No.: 19/342,644

(22) Filed: Sep. 28, 2025

Related U.S. Application Data
(60) Provisional application No. 63/701,296, filed on Sep. 30, 2024.

(51) Int. Cl. E04B 1/98; F16F 3/093

(52) U.S. Cl. CPC E04B 1/98; F16F 3/0935

(57) ABSTRACT

An elastomer system includes a block of elastomer, and one or more bands of fibrous material circumferentially coupled to the block of elastomer along an axial direction, wherein each of the one or more bands includes one or more layers of fibrous material adhesively attached to the block of elastomer or to other layers of the one or more layers of fibrous material.

### CROSS-REFERENCE TO RELATED APPLICATIONS

The present non-provisional patent application is related to and claims the priority benefit of U.S. Provisional Patent Application Ser. No. 63/701,296, filed Sep. 30, 2024, the contents of which are hereby incorporated by reference in its entirety into the present disclosure.

### STATEMENT REGARDING GOVERNMENT FUNDING

None.

### TECHNICAL FIELD

The present disclosure is related to base isolation for vibration mitigation of structures such as general buildings, bridges and other structures, and in particular related to vibration mitigation during a seismic activity.

### BACKGROUND

This section introduces aspects that may help facilitate a better understanding of the disclosure. Accordingly, these statements are to be read in this light and are not to be understood as admissions about what is or is not prior art.

Seismic isolation is a vibration mitigation technique to protect structures from severe earthquake events. Various isolation systems have already been disclosed, which are broadly categorized into elastomeric bearings, sliding isolation systems, and rolling isolation systems. Some of these isolation systems are used in practice to protect various types of structures from earthquakes. Although different isolation systems implemented in practice are effective in reducing the structural responses against earthquakes, there exist a few drawbacks. For instance, sliding systems wherein its performance depends on the shape of the sliding surface, coefficient of friction, and the intensity of earthquake, have the disadvantage of having permanent (residual) displacements under strong earthquakes. On the other hand, elastomeric bearings with steel shim reinforcements, such as laminated rubber bearings or lead rubber bearings are heavy and hence difficult as well as costlier to implement in field. Several patent literature documents are discussed below:

U.S. Pat. No. 5,904,010 to Javid et al. describes a fiber-reinforced elastomeric bearing and method to protect structures and its contents from strong earthquake excitations. The bearing is composed of a block of composite materials containing elastomeric matrix which is embedded with high stiffness pretensioned fibers aligned in various horizontal directions used as strengthening shims. The isolators display very low stiffness in the horizontal direction as compared to the vertical stiffness. Thus, the placement of such bearings between the structure and its foundation decouples the structure from its foundation.

Japanese Pat. No. JP2005061211A describes a vibration isolator that provides three-dimensional vibration isolation. This is useful for the isolation of the structure against both, horizontal and vertical components of strong earthquake excitations. The vibration isolator is manufactured using a disc spring connected to the vibration isolation object with a vertical gap between the vibration isolation object and the lower structure. A moving mechanism using ball bearing is used for the horizontal direction isolation with an elastic element to add resiliency to the bearing. Although the proposed device provides three-dimensional vibration isolation, the fabrication and setup of this device is quite complicated.

International Pat. Pub. WO 2008/098982 A2 describes a seismic isolator, and its method of production, composed of elastomers and fibers used as reinforcing shims to provide flexibility to structures against earthquake excitations. The isolator stays connected to the structure only by the means of friction without any other attachments. The isolator can be of cubic, curvilinear, rectangular parallelopiped or elongated rectangular parallelopiped shape. The layers of elastomers and fiber reinforcements are alternately placed inside the mold and glued together by the means of pressure and temperature.

International Pat. Pub. WO 2008/148203 A1 describes a stable unbonded fiber-reinforced isolator bearing for isolation of structures such as low-to medium-rise buildings, bridges and other structures. The isolator consists of a plurality of elastomer and fiber sheets bonded together in alternate layers. The top and bottom surfaces of the isolator are not fixed with the supports; thus, the isolator displays rollover deformation under horizontal shear loading. Due to rollover deformation, the isolator becomes flexible with increase in horizontal displacement until the vertical face of the isolator comes in full contact with the supports; post which, the horizontal stiffness of the isolator increases.

U.S. Pat. No. 9,429,205 B2 to Tait and Canadian Pat. No. CA2864006C describe an elastomeric isolator which eliminates the limitations of the unbonded fiber-reinforced elastomeric isolators (FREIs) by partially bonding the isolators with the top and bottom steel plates. This configuration allows the isolator to experience rollover deformation at the same time establishing means to transfer the tensile forces and restrict permanent deformations of the isolated building. The isolator is composed of alternate layers of elastomers and fiber reinforcement bonded with each other.

Indian Pat. No. IN201631021115A describes an elastomeric seismic isolator with high damping capacity and its method of preparation, for use in low-to medium-rise buildings, bridges, and other structures. The process of manufacturing the isolator involves stacking alternate layers of vulcanized elastomeric sheets and composite layers of carbon fiber system, inside a steel mold box. Thereafter, the elastomeric isolator is ready for use after a relatively simple curing procedure.

U.S. Pat. No. 11,002,032 B2 to Almazán et al. describes a self-centering and energy-dissipating seismic isolation device using elastomeric-frictional type mechanism for vibration control of structures. The device is composed of one lower bottom plate which is fixed to the foundation, over which lays an elastomeric ring with decreasing diameter in the direction of the column. The top plate lies on the elastomeric ring with a spherical curved-concave inner surface part over it. Further, a central metal bar fixes the entire device together. The structure to be isolated may comprise of several of these devices or one device with sliding supports at other locations.

The aforementioned patent literature is related to elastomeric bearings with special attention towards fiber-based reinforcing shims revealing the state-of-the-art. All the existing bearings include fiber reinforcements laid inside the elastomeric isolators in the form of layers or shims. These isolators are efficient when the structural response is dominated by the horizontal components of earthquakes. However, there is also a need for an isolation system having the capability to isolate a superstructure in the vertical direction, without significant additional costs. Further, the bulging of the elastomeric pad needs to be kept under control at vertical and horizontal loading.

Therefore, there is an unmet need for a novel structural system that can provide vibration isolation during seismic activities which can provide improved protection against vertical and horizontal loading.

### SUMMARY

An elastomer system is disclosed. The system includes a block of elastomer, and one or more bands of fibrous material circumferentially coupled to the block of elastomer along an axial direction. Each of the one or more bands includes one or more layers of fibrous material adhesively attached to the block of elastomer or to other layers of the one or more layers of fibrous material by an adhesive.

An anti-seismic isolation elastomer system is also disclosed. The anti-seismic isolation elastomer system includes a plurality of isolation blocks. Each isolation block includes a block of elastomer, and one or more bands of fibrous material circumferentially coupled to the block of elastomer along an axial direction. Each of the one or more bands includes one or more layers of fibrous material adhesively attached to the block of elastomer or to other layers of the one or more layers of fibrous material by an adhesive.

### BRIEF DESCRIPTION OF DRAWINGS

FIG. 1 is a general schematic for a seismic isolator placed between the base of a superstructure and a top portion of a foundation/support.

FIG. 2 is a detailed diagram showing construction of an individual rectangular shape bonded fiber-confined elastomeric isolator (FCEI), according to the present disclosure.

FIG. 3 is a detailed diagram showing construction of an individual rectangular shape unbonded FCEI, according to the present disclosure.

FIG. 4 is a schematic elevation view of a bonded FCEI fixed in between a base of a superstructure and a foundation, in its original position, without any lateral deformation.

FIG. 5 is a schematic elevation view of an unbonded FCEI which is placed in between a base of a superstructure and a foundation, in its original position, without any lateral deformation.

FIG. 6 is a schematic elevation view of a bonded FCEI, fixed in between a base of a superstructure and a foundation in a horizontally deformed position.

FIG. 7 is a schematic elevation view of an unbonded FCEI, placed in between a base of a superstructure and a foundation in a horizontally deformed position.

FIG. 8 is a typical fiber fabric confinement, according to the present disclosure.

FIGS. 9a, 9b, and 9c are schematic diagrams of three different configurations of an isolator, according to the present disclosure.

FIG. 10 is a graph of vertical pressure in MPa vs. time in seconds showing effective compressive stiffness values that are based on finite element analysis (FEA) simulations using a cyclical loading.

FIG. 11 is a load profile in a graph of horizontal displacement in mm vs. time in seconds for a horizontal shear analysis.

FIG. 12 is a graph of force in N vs. displacement in mm showing results of compression simulations for different configurations of the isolator of the present disclosure.

FIG. 13 is a graph of force in N vs. displacement in mm showing results of shear simulations for different configurations of the isolator of the present disclosure.

FIG. 14 is a schematic of a cylindrical shape pad with one fibrous band having one layer, similar to the embodiment shown in FIG. 9a.

FIG. 15 is a graph of force in N vs. displacement in mm showing the compressive stiffness of the circular FCEI of the present disclosure is higher than that of the square isolator.

FIG. 16 is a graph of force in N vs. displacement in mm showing the shear stiffness of the circular isolator is significantly less than the square isolator.

FIGS. 17 and 18 are graphs of force in N vs. displacement in mm showing compressive and shear results, respectively, from simulations of a cubical rubber block as compared to the structure shown in FIG. 9a.

FIG. 19 is another embodiment of an isolator, according to the present disclosure, where a number of elastomer layers (e.g., 2 or more) can be provided with inlay fibrous layers (one or more) disposed in between said elastomer layers to generate a full construction.

FIG. 20 is a schematic shown in an elevation view and a plan view of a proof-of-concept embodiment for one embodiment of the isolator of the present disclosure.

FIG. 21 is a photograph of three samples of the embodiment shown in FIG. 20.

FIG. 22a is a photograph of a test set-up for testing the isolators of the present disclosure.

FIG. 22b is a graph of compressive load in kN vs. time in seconds showing the test protocol for the cyclic compressive loading with 0.5 Hz frequency.

FIG. 23 is a graph of force in kN vs. displacement in mm showing force-deformation behavior of the FCEIs of FIG. 21 under only compression load.

FIGS. 24a and 24b are photographs of a shear test setup (both in undeformed state, FIG. 24a, and deformed state, FIG. 24b) for the FCEIs of FIG. 21.

FIG. 24c is a graph of displacement in mm vs. time in seconds showing the test protocol for the cyclic shear loading with 0.5 Hz frequency.

FIG. 25 is a graph of force in kN vs. displacement in mm showing force-deformation behavior of prototype FCEIs of FIG. 21 under constant compression and cyclic shear loads.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

A novel structural system is disclosed herein that can provide vibration isolation during seismic activities with improved protection against vertical and horizontal loading. Towards this end, fibrous material is used as a wrapping material around a block of elastomer to achieve improved isolation properties. The present disclosure describes a fiber-confined elastomeric isolator (FCEI) for structures such as general buildings, bridges, and other structures, to protect them against earthquakes. The FCEI, according to one embodiment, is composed of a single elastomeric block confined with one or more bands of fibrous material that are disposed centrally or semi-centrally circumferentially around the block of elastomer, wherein each of the bands is composed of one or more layers of the fibrous materials. The fibrous material is adhesively attached to the block of elastomer, while if there are more than one layer, each of the layers not in contact with the elastomer is also adhesively attached to the other layers. There exist two possible attachment configurations of the FCEIs, first, where the elastomeric pad (also referred to herein as block of elastomer) is fixedly attached to two steel plates disposed at the top and bottom surfaces of the elastomeric pad. Further, the steel plates are fixedly connected to the superstructure and the substructure creating a bonding between the isolator and the structure. Therefore, this isolator is termed as the bonded FCEI. Secondly, the isolator may be directly placed between the superstructure and the substructure without the need of being connected to external steel plates. In this case, the FCEI is not fixed with the structure, thus it is termed as the unbonded FCEI.

The fiber fabric confinements are provided around the elastomeric pad to resist the excessive bulging of the elastomer, thus protecting the elastomer from tearing. The fiber fabric confinement could be placed having various dimensions. The width of each fiber fabric confinement, spacing between two consecutive fiber fabric confinements, number of layers of fiber fabric in each fiber fabric confinement, and the type of fiber in each fiber fabric confinement to be used could be designed specific to the requirements for a corresponding structure. To reduce and limit the bulging of elastomer, each fiber fabric confinement may include a plurality of fiber layers overlapped on each other. The alignment of the fibers in the fabric could be unidirectional, bidirectional or even triaxially-braided, and could be wrapped around the elastomeric pad at any angle with the horizontal axis. Further, the confinement of the elastomeric pad might be similarly provided by utilizing fiber ropes instead of fiber fabric. The fiber ropes or fiber fabric utilized could be pretensioned, chemically treated, or thermally treated for obtaining enhanced mechanical properties. The basic objective of addition of fiber fabric confinements is to resist the excessive bulging of the elastomer.

The working principle of the innovation of the present disclosure is unique as compared to the existing elastomeric bearings. The relative displacement between the top and bottom surfaces of the FCEI in the horizontal direction exerts a nonlinear restoring force on the superstructure and the substructure, thus resisting the motion of the superstructure. The uniqueness in the behavior of the FCEI of the present disclosure lies in its substantially high flexibility. This ensures effective isolation of the superstructure from the substructure with minimal design complications. In unbonded applications, the behavior of the FCEI is even more flexible, thus further alleviating its isolation efficiency.

The restoring force exerted by the isolator on the structure is dependent on the elastomeric material being used, dimensions of the FCEI, total vertical load acting on the FCEI, and the type and configuration of the fiber fabric confinement(s) and the fabric layer(s) in each fiber fabric confinement. However, the optimal FCEI for the intended application could be estimated and prepared with relatively low efforts. The cost of production of the novel FCEIs is considerably lower owing to the simplification in its manufacturing process and also the use of readily available and economical materials. The FCEIs could be manufactured by utilizing only local sustainable materials such as natural rubber for the elastomeric pad and natural fiber fabric or rope for the confinements.

In addition to the good isolation capabilities in the horizontal direction, the FCEI of the present disclosure isolates the superstructure in the vertical direction as well. This feature of the FCEI is not reported in most of the prior seismic isolation systems in practice wherein the horizontal isolation properties are on focus. The flexibility of the FCEI in the vertical direction is due to the utilization of the complete elastomeric pad as one unit rather than dividing it into several layers. This feature is an important addition because numerous structural and non-structural damages are also caused from the devastating vertical components of the earthquake excitation.

The FCEI of the present disclosure can be installed under the superstructure which needs to be isolated, and also it can be effectively used for retrofitting of structures. Further, after a strong earthquake, the isolators of the present disclosure could be repaired or replaced using minimum efforts, if required. The fabrication, placement, and maintenance of this system can be handled quite effortlessly due to its simplicity. In unbonded applications, the isolators are simply required to be placed between the substructure and the superstructure without any attachments. When in use, the isolators remain in their positions due to the self-weight of the structure.

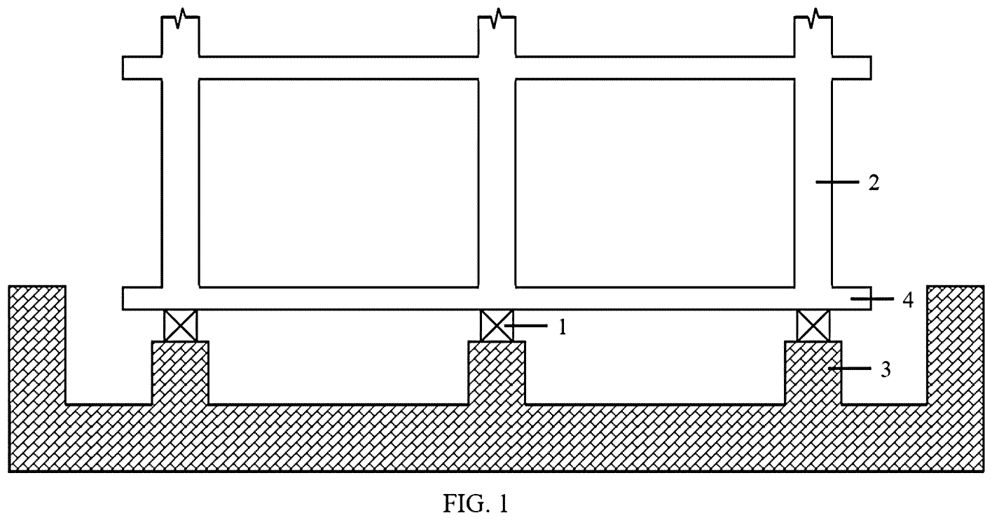

Referring to FIG. 1, a general schematic is provided for a seismic isolator (also referred to herein as fiber-confined elastomeric isolators, also referred to herein as FCEIs) 1, also generally referred to herein as the isolator, is placed between the base of a superstructure 2 and a top of a foundation/support 3. The FCEIs 1 are placed below the base slab 4 on which the superstructure 2 is built/positioned, or below the vertical load carrying members in the superstructure 2 that transfers the load from the structure to the foundation 3.

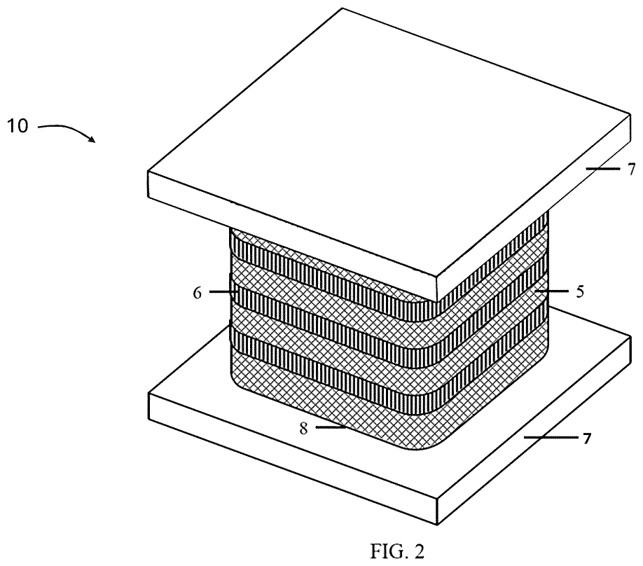

Referring to FIG. 2, a schematic providing a detailed construction of an individual rectangular shape bonded FCEI 10 is provided, according to the present disclosure. In the bonded applications, the bonded FCEI 10 is placed between two steel plates 7 at the top and bottom of the isolator. The steel plates are then fixedly attached to the base of the superstructure 2 and to the foundation/support 3 (see FIG. 1).

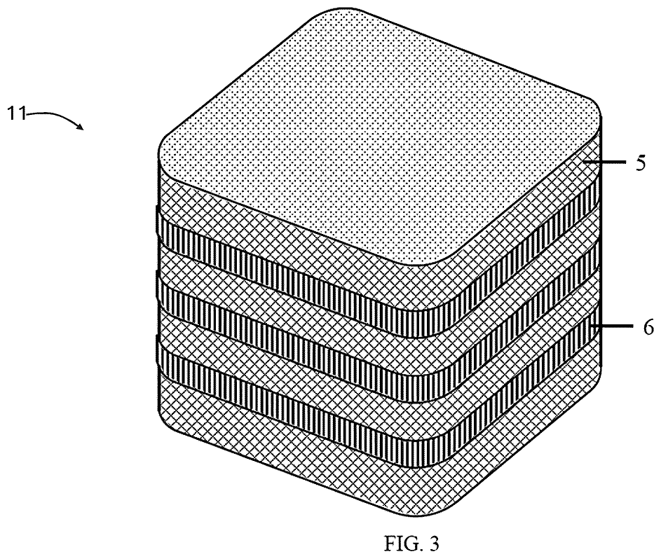

Referring to FIG. 3, a schematic providing a detailed construction of an individual rectangular shape unbonded FCEI 11 is provided, according to the present disclosure. In the unbonded applications, the isolator is directly placed between the base of the superstructure 2 and the foundation/support 3. In both FIGS. 2 and 3, the FCEI (i.e., the bounded FCEI 10 and the unbounded FCEI 11) is constructed utilizing an elastomeric pad 5 (in the shown figures, the pad 5 is a block of elastomer formed in a cubical shape) with suitable dimensions and material. The elastomeric pad 5 can have rectangular or circular cross-sections, while other shapes, such as pentagon, hexagonal, octagonal, are within the ambit of the present disclosure. In rectangular FCEIs, the corners of the isolator are rounded intentionally to prevent excessive concentration of stresses in the corners of the fiber fabric confinement 6. In both bonded and unbonded FCEIs 10 and 11, respectively, the basic isolation mechanism remains similar, where the flexible elastomeric pad 5 deforms in the horizontal direction and exerts the horizontal shear force to the superstructure 2, in the event of an earthquake. The percentage of damping exhibited by the isolators will depend on the material used in the elastomeric pad 5. A large variety of elastomer materials are available for the construction of the proposed isolator. The fiber fabric confinement 6 are used to prevent the elastomeric pad 5 from bulging outwards, thereby avoiding the possibility of tearing of the elastomer due to the self-weight of the structure. In bonded applications, additionally, there exists a permanent bond 8 (shown in FIG. 2) between the elastomeric pad 5 and the steel plates 7. As shown in FIGS. 2 and 3, there are three bands of fibrous material referred to herein as fiber fabric confinement 6. Depending on the application, the number of fibrous bands can be less (e.g., 2 or 1), or more. Each such fibrous band may include one or more fibric layers. The fiber layer closest to the elastomeric pad 5 is fixedly attached to the elastomeric pad 5 using an adhesive. If there is more than one fabric layer, the consecutive layers extending outward from the pad are also fixedly attached to the neighboring layer with the adhesive.

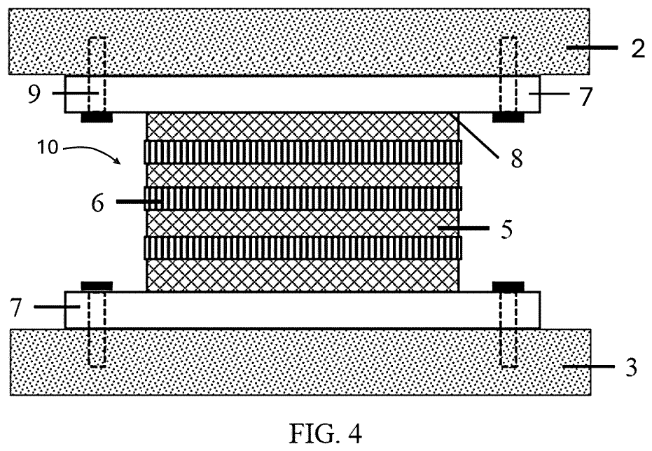

Referring to FIG. 4, a schematic elevation view of a bonded FCEI 10 fixed in between the base of the superstructure 2 and the foundation/support 3, is provided in its original position, without any lateral deformation. The bonded FCEI 10 is attached to the superstructure 2 and the foundation/support 3 by bolts 9 fixing the top and bottom steel plates 7 to the base of the superstructure 2 and the foundation/support 3, respectively. This bolting of the isolator 10 to the structure ensures the bonded nature of the isolator 10.

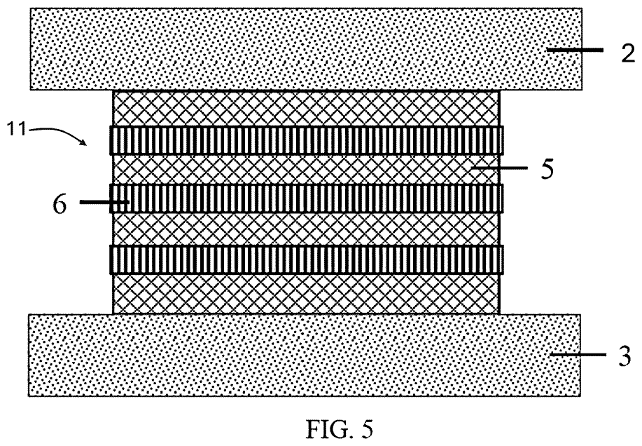

Referring to FIG. 5, a schematic elevation view of an unbonded FCEI 11 is provided which is placed in between the base of the superstructure 2 and the foundation/support 3, in its original position, without any lateral deformation. In the case of unbonded FCEI 11, the isolator 11 is placed in between the base of the superstructure 2 and the foundation/support 3 without any permanent bond. The isolator 11 remains in position due to the self-weight of the structure acting vertically on the isolator 11.

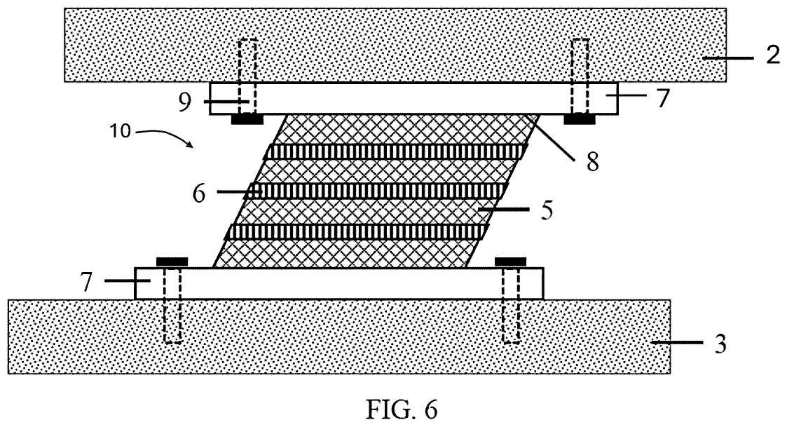

Referring to FIG. 6, a schematic elevation view of a bonded FCEI 10, fixed in between the base of the superstructure 2 and the foundation/support 3 is provided in its horizontally deformed position. In the case of the bonded FCEI 10, the top surface of the elastomeric pad 5 deforms consistently with the top steel plate 7.

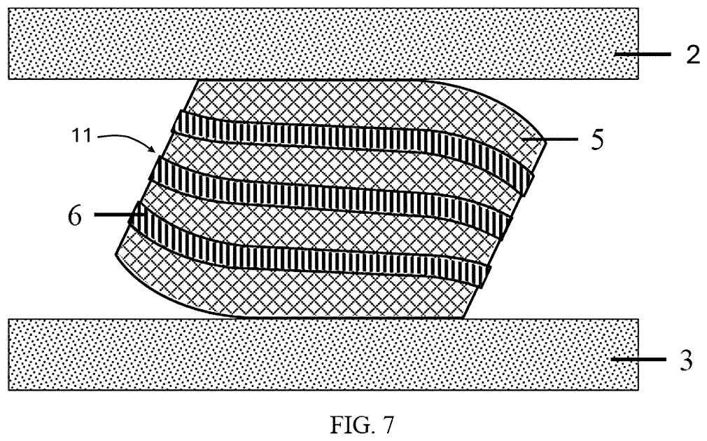

Referring to FIG. 7, a schematic elevation view of an unbonded FCEI 11, placed in between the base of the superstructure 2 and the foundation/support 3 is provided in its horizontally deformed position. In the case of the unbonded FCEI 11, the top and bottom surfaces of the elastomeric pad 5 roll over after a certain displacement, thus making the isolator more flexible in nature. For unbonded FCEIs 11, the isolator 11 has to be designed carefully such that the isolator 11 does not lose stability under large horizontal displacements. Nevertheless, the unbonded FCEIs 11 are lighter in weight and easier to implement in the field as compared to the bonded FCEIs 10.

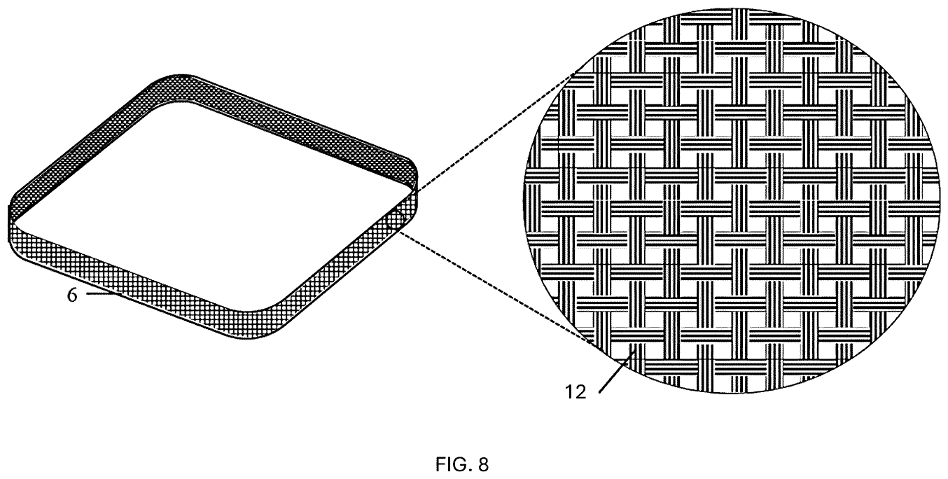

Referring to FIG. 8, a typical fiber fabric confinement 6 is shown. The fiber fabric confinement 6 is composed of one or more layers of fiber fabric each layer constructed by weaving multiple strands of fiber together in the form of a consistent fabric material. The strength of the fiber fabric confinement 6 will depend on the type of fiber utilized. The fibers may be arranged in various orientations to form the fiber fabric confinement 6. FIG. 8 provides a schematic diagram where the fiber strands 12 are oriented bidirectionally to generate the fiber fabric confinement 6, having only one layer of fiber fabric. The bonded and unbonded FCEIs 10 and 11, respectively, are manufactured using one or more of these fiber fabric confinement(s) 6 each having one or more layers of fiber fabric layers arranged at a certain spacing along the height of the elastomeric pad 5. Further, as discussed above, multiple layers of fiber fabric could be used together at the same location one on top of another to thereby compose one fiber fabric confinement 6, to enhance the strength of the fiber fabric confinement 6.

The block of elastomer may be typically made of natural rubber, neoprene, ethylene-propylene rubber, nitrite rubber, halogenated butyl rubber, isoprene rubber, styrene-butadiene rubber, butadiene rubber, acrylic rubber, polyurethane rubber, or other suitable elastomers. Where neoprene is used, the material typically provides a hardness (International rubber hardness degrees, IRHD) of about 60, elongation at break of about 400%, and shear modulus of about 0.7 MPa. The fibrous material may be made of carbon fiber fabric, basalt fiber fabric, glass fiber fabric, steel fiber fabric, or other suitable natural or synthetic fiber fabrics or ropes. Typically, carbon fiber fabric having a Young's modulus of about 4400 MPa and a Poisson's ratio of about 0.2 could be used as the fiber fabric confinements 6.

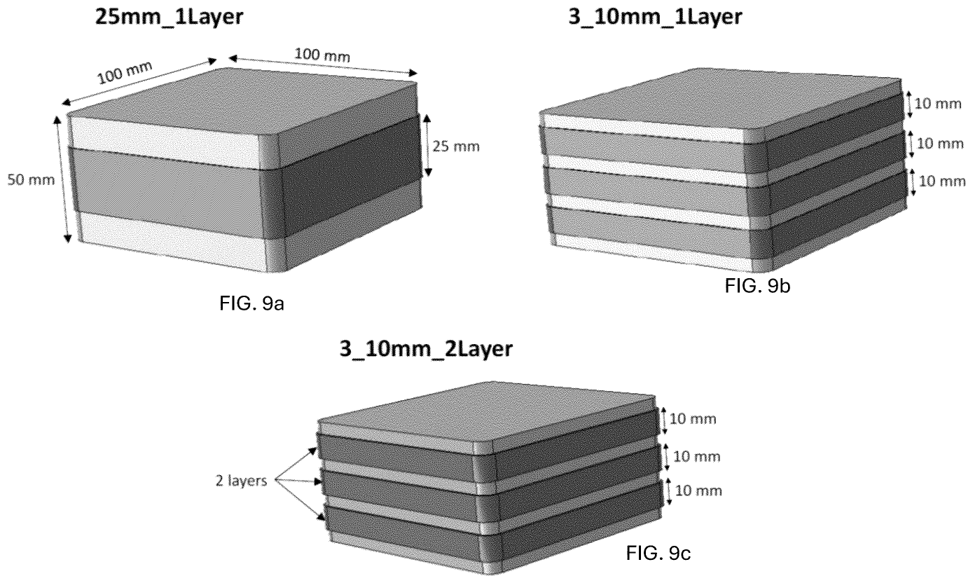

Referring to FIGS. 9a, 9b, and 9c three different configurations of the isolator are provided. In FIG. 9a, a neoprene rubber pad is wrapped by a single band of carbon fiber fabric, wherein the block of elastomer is formed in a cubical shape having a width, length, and a height with one centrally disposed band having one layer and having a band thickness of about 0.55% of the cube width and a band height of about 50% the cube height with an effective compressive stiffness (K_{eff-comp}), defined as (maximum compressive force-minimum compressive force)/(maximum compressive displacement-minimum compressive displacement), of about 3081 N/mm, and more generally between about 500 N/mm to about 100,000 N/mm, depending on construction and application.

For the structure shown in FIG. 9a, an effective shear stiffness (K_{eff-shear}), defined as (maximum shear force-minimum shear force)/(maximum shear displacement-minimum shear displacement), is about 160 N/mm, and more generally between about 10 N/mm to about 30,000 N/mm, depending on construction.

In FIG. 9b, a pad is wrapped by three bands of fibrous material, wherein the block of elastomer is formed in a cubical shape having a width, length, and a height with three centrally disposed bands each band having one layer and each band having a band thickness of about 0.55% of the cube width and a band height of about 20% the cube height where the effective compressive stiffness (K_{eff-comp}) is about 3137 N/mm, and more generally between about 500 N/mm to about 100,000 N/mm, depending on construction.

For the structure shown in FIG. 9b, the effective shear stiffness (K_{eff-shear}) is about 158 N/mm, and more generally between about 10 N/mm to about 30,000 N/mm, depending on construction.

In FIG. 9c, a pad is wrapped by three bands, wherein the block of elastomer is formed in a cubical shape having a width, length, and a height with three centrally disposed bands each band having two layers and each band having a band thickness of about 0.55% of the cube width and a band height of about 20% the cube height with the effective compressive stiffness (K_{eff-comp}) comp) is about 3631 N/mm, and more generally between about 500 N/mm to about 100,000 N/mm, depending on construction.

For the structure shown in FIG. 9c, an effective shear stiffness (Keff-shear) is about 161 N/mm, and more generally between about 10 N/mm to about 30,000 N/mm, depending on construction.

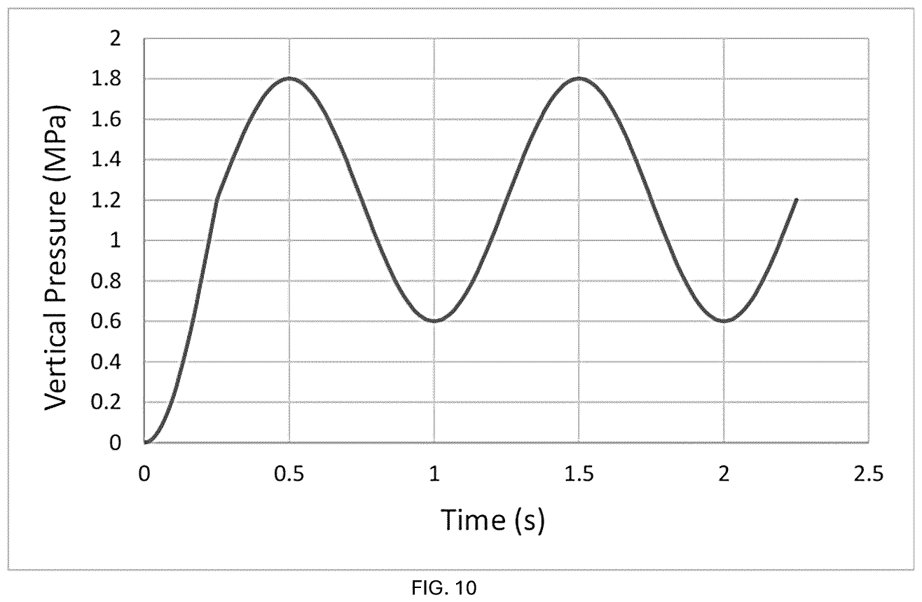

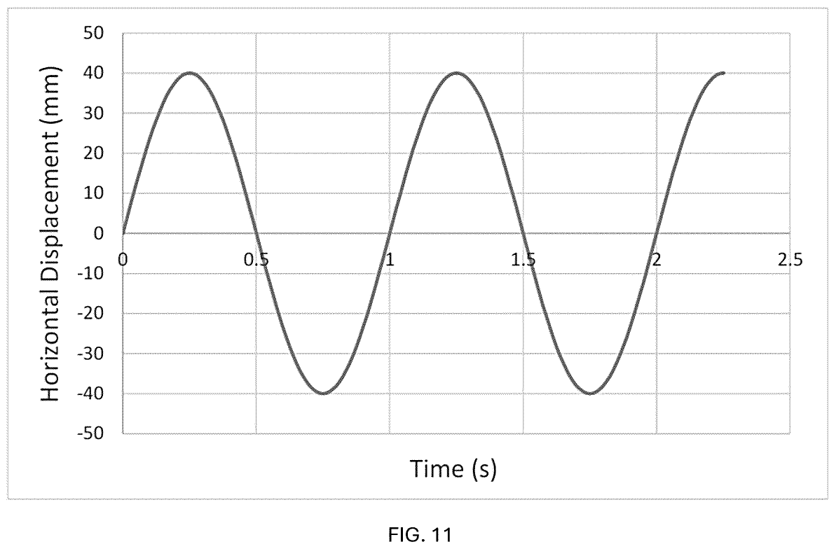

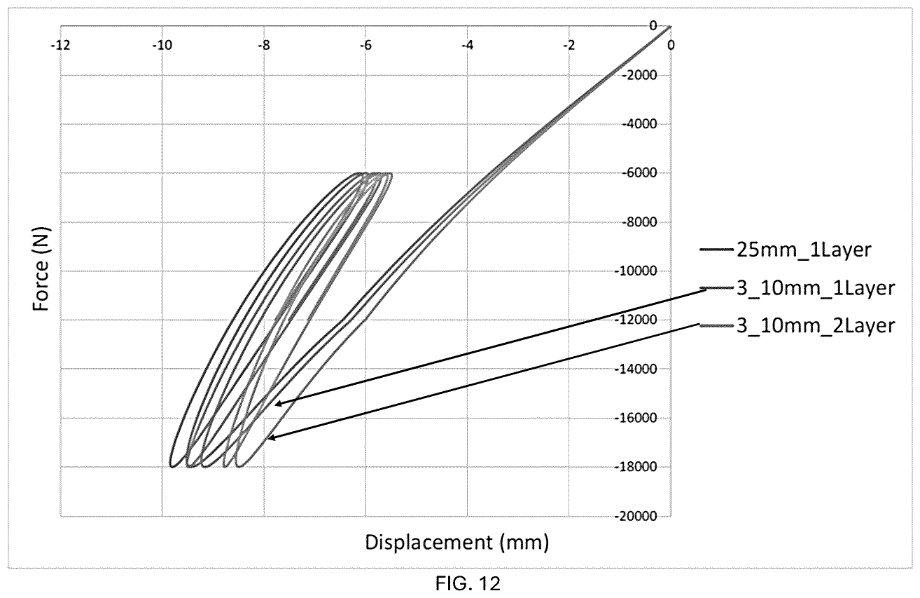

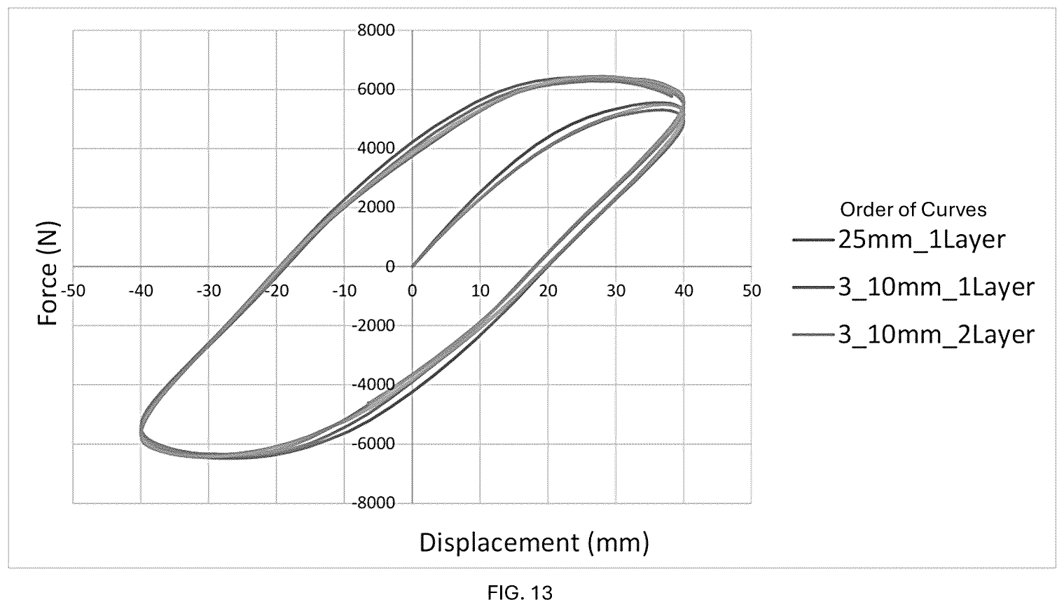

The above effective compressive stiffness values are based on finite element analysis (FEA) simulations using a cyclical loading as shown in FIG. 10, which is a graph of vertical pressure in MPa vs. time in seconds. First, the vertical pressure is increased to 1.2 MPa, then a cyclic pressure variation is applied with 0.6 MPa amplitude. For the horizontal shear analysis, the load profile is shown in FIG. 11, which is a graph of horizontal displacement in mm vs. time in seconds. Here, the horizontal displacement on the isolator varies with time. Two full cycles of loading were applied in the FEA simulations. The results of the compression simulations are provided in FIG. 12 while the results of shear simulation are provided in FIG. 13 (in FIG. 13, individual curves are not identified due to close proximity to one another).

As observed from FIG. 12, the vertical stiffness of the isolators increases due to higher fabric confinement, i.e., from 1 layer, 25 mm (see FIG. 9a) to 1 layer, 3×10 mm (see FIG. 9b) to 2 layers, 3×10 mm (see FIG. 9c). However, all the three FCEIs demonstrate similar horizontal force-deformation behavior, as seen in FIG. 13.

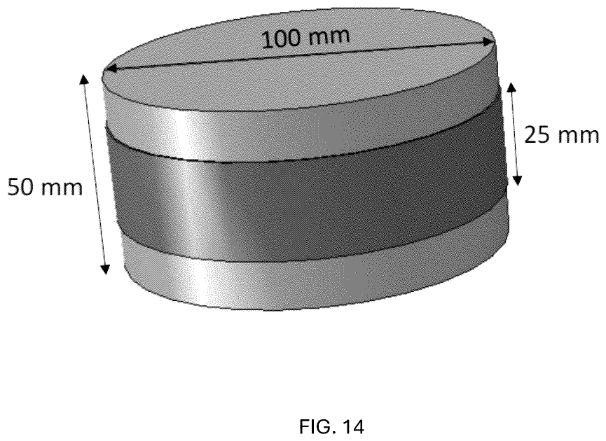

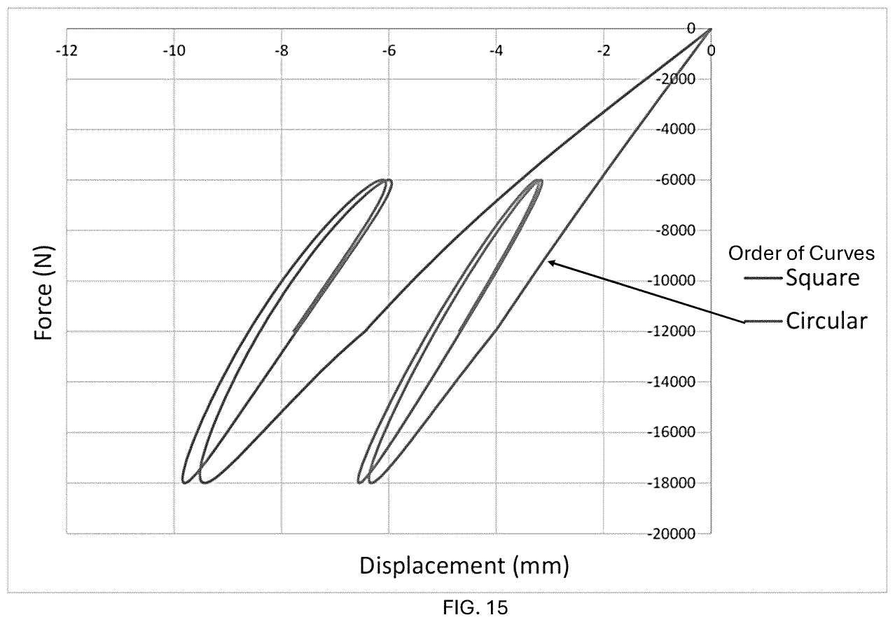

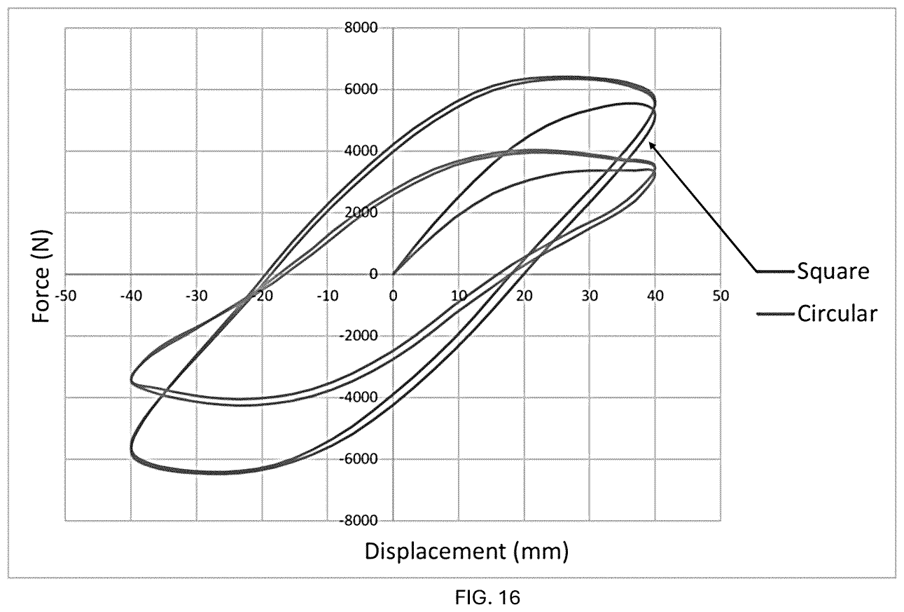

Referring to FIG. 14, a cylindrical shape pad is also shown with one fibrous band having one layer, similar to FIG. 9a. The performance of the circular FCEI (see FIG. 14) is compared to the performance of the square FCEI having a single layer of 25 mm fiber fabric confinement (25 mm_1 Layer, see FIG. 9a), which is referred to as the square FCEI generally from hereon. The circular FCEI is subjected to the same loading profiles as shown in FIGS. 10 and 11. Therefore, FIGS. 15 and 16, respectively, show the compression and shear performance of the circular FCEI when compared to the performance of square FCEI.

As observed in FIG. 15, the compressive stiffness of the circular FCEI is higher than that that of the square isolator. However, FIG. 16 shows that the shear stiffness of the circular isolator is significantly less than the square isolator. The primary reason for this performance is the reduced cross-sectional area of the circular FCEI, which is generally one of the design parameters of the FCEIs.

The pad shown in FIG. 14 is wrapped by a single band of fibrous material, wherein the block of elastomer is formed in a cylindrical shape having a diameter and a height with the one centrally disposed band having one layer and having a band thickness of about 0.55% of the cylinder diameter and a band height of about 50% the cylinder height where the effective compressive stiffness (Keff-comp) is about 3502 N/mm, and more generally between about 500 N/mm to about 100,000 N/mm. The pad shown in FIG. 14 has an effective shear stiffness (K_{eff-shear}) of about 100 N/mm, and more generally between about 10 N/mm to about 30,000 N/mm.

It should be appreciated that all dimensions discussed above (% or actual numbers) are provided as examples only, and other dimensions can be implemented based on loading requirements.

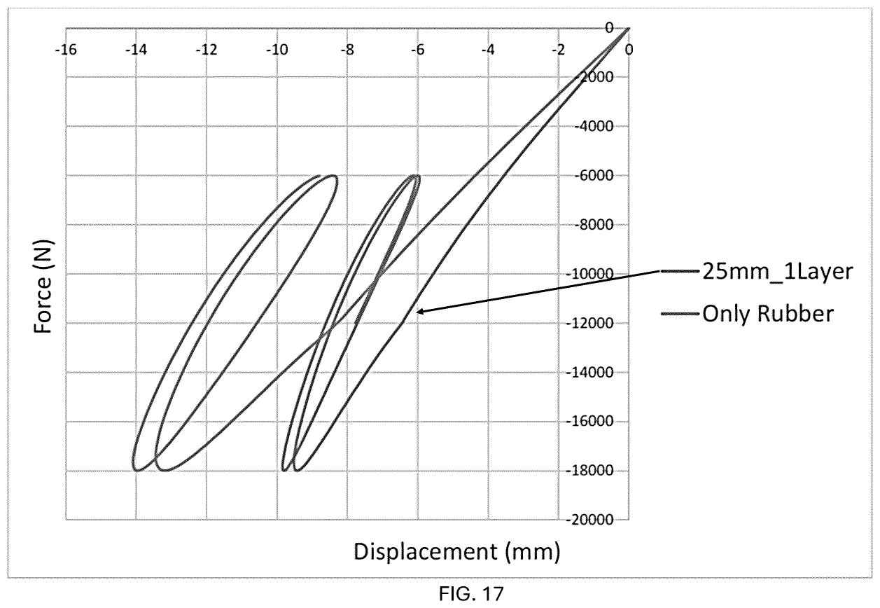

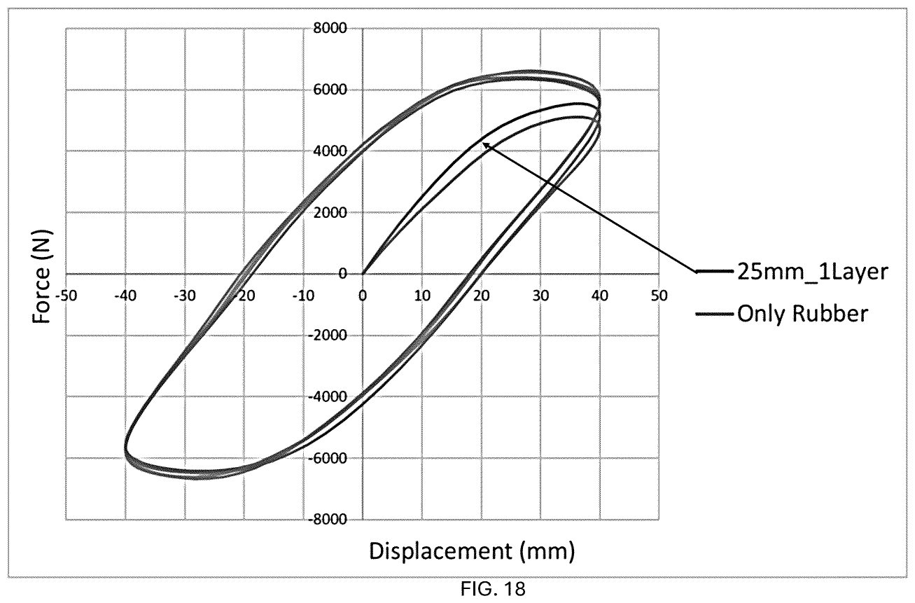

To show the effectiveness of the fibrous bands, compressive and shear results from simulations of only a cubical rubber block without any fibrous bands as compared to the structure shown in FIG. 9a are shown, as provided in FIGS. 17 and 18, respectively. As observed from FIG. 17, the rubber block without confinement is much more flexible than the FCEI, exhibiting a much lower vertical stiffness. However, FIG. 18 shows that the rubber block also behaves similarly in shear as compared to the FCEI with fiber confinement.

In the case of the rubber-only pad (i.e., with no fiber fabric confinement), wherein the block of elastomer is formed in a cubical shape having a width, length, and a height, has an effective compressive stiffness (K_{eff-comp}) of about 2068 N/mm, and more generally between about 500 N/mm to about 100,000 N/mm; and where the effective shear stiffness (K_{eff-shear}) is about 166 N/mm, and more generally between about 10 N/mm to about 30,000 N/mm. It should be noted that the stated stiffness numbers are provided for example purposes only and other stiffness numbers associated with proper loading in a construction environment may be substituted.

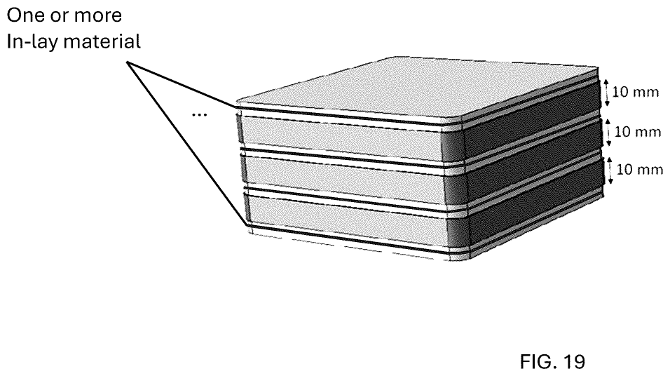

According to an alternative embodiment, the fiber reinforcement may be one or more fibrous ropes. In any such embodiments, the fibrous reinforcement (bands or ropes) may be provided with varying circumferential angle of disposition over the elastomer block (e.g., 45°). Furthermore, the elastomer pads may be constructed using inlays of reinforcement materials (e.g., inlay fibrous layers) that provide additional stability and strength. The fibrous reinforcement bands are disposed over the elastomer portion(s) to provide the reinforcement, as described in the present disclosure. This configuration is shown in FIG. 19, where a number of elastomer layers (e.g., 2 or more) can be provided with inlay fibrous layers (shown as one or more in-lay material) disposed in between said elastomer layers to generate the full construction.

It should be appreciated all absolute and relative dimensions including number of fibrous bands provided herein are for purpose of examples and no limitation is intended thereby. Thus, dimensions can vary based on loading requirements.

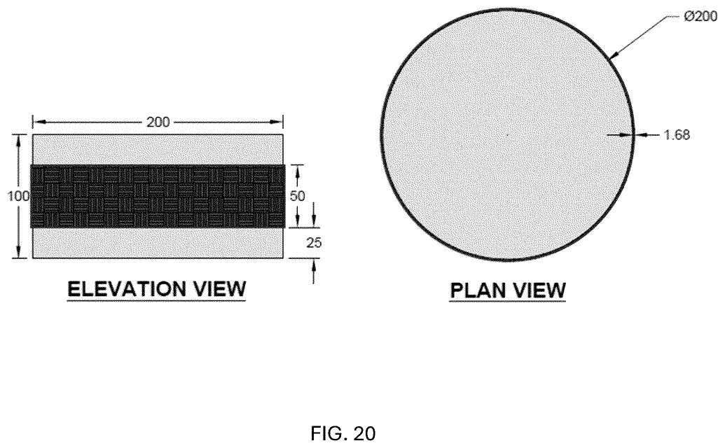

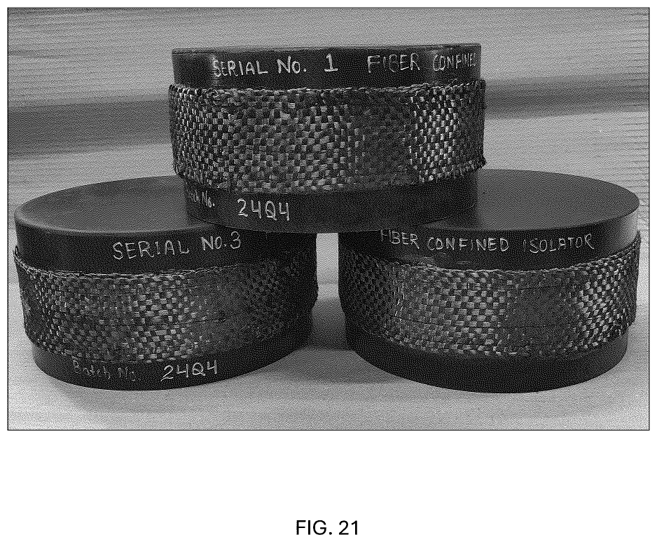

To evaluate the isolators discussed herein, prototype FCEIs were fabricated and tested. Referring to FIG. 20, a schematic including an elevation view and a plan view of a proof-of-concept embodiment for one embodiment of the isolator of the present disclosure is provided. The isolators of FIG. 20 are circular in shape with example dimension 200 mm diameter and a height of 100 mm. Natural rubber with shore A hardness of 60 is utilized as the elastomer for the isolator. A single fiber fabric confinement having four layers of carbon fiber fabric are wrapped around the elastomer (rubber) at mid height, each layer being, e.g., 50 mm in width. The thickness of each of the four fiber fabrics is, e.g., 0.42 mm, making the thickness of the fiber fabric confinement a total of, e.g., 1.68 mm. The fiber fabric is attached to the elastomer using epoxy (adhesive) to ensure fixed connection of the fabric to the elastomer and each fiber fabric layer to another fiber fabric layer. The fiber fabric confinement prevents excessive bulging of the elastomer under high compressive forces as well as provides shear resistance under large shear deformations of the isolators. FIG. 21 is a photograph of three samples of the embodiment shown in FIG. 20.

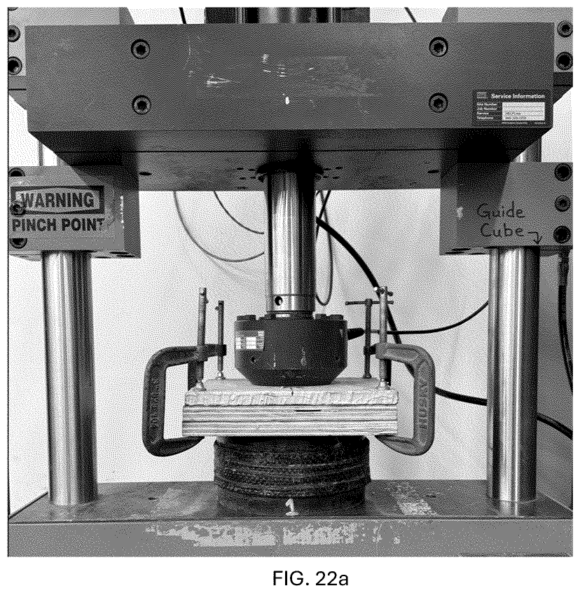

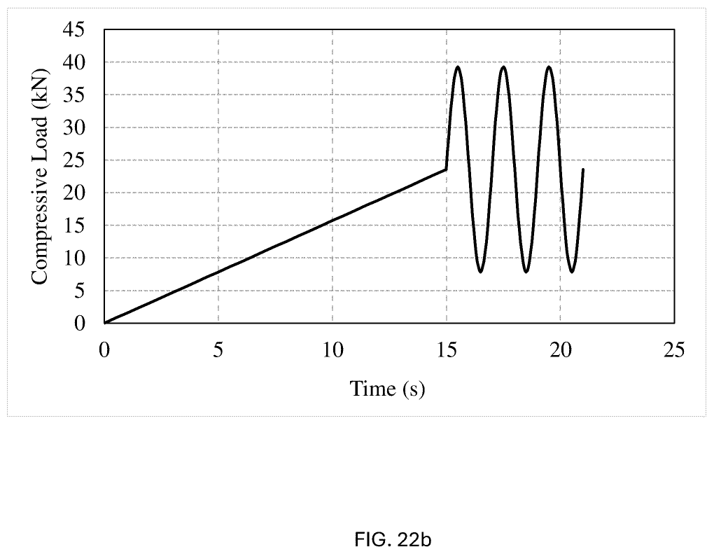

Two sets of tests were conducted on the three FCEIs: (a) compression tests for evaluating its compressive stiffness and (b) shear tests under constant compression for evaluating the shear behavior of the isolators. FIG. 22a is a photograph of a test set-up for testing the isolators shown in FIG. 21. A fatigue-rated hydraulic actuator is utilized with 50 kN maximum force capacity. Initially, static compression tests were conducted to verify the load-carrying capacity of the isolators. It was found that the isolators did not show any visible damage when subjected to loads up to 48 kN. Thereafter, cyclic compression tests were conducted on the isolators. To subject the isolators to only compressive loads and not tensile loads, an initial ramp of 23.55 kN was applied to the isolator, which is equivalent to 0.75 MPa of vertical pressure. Subsequently, three cycles each of 6.28 kN, 10.99 kN, and 15.70 kN amplitude loads were applied. The test was conducted in load-controlled mode. The three amplitudes of forces correspond to 0.2 MPa, 0.35 MPa, and 0.5 MPa vertical pressure, respectively. This loading protocol is repeated for all the three isolators of FIG. 21. Moreover, the same protocol is repeated for three different frequencies: 0.05 Hz, 0.25 Hz, and 0.5 Hz. FIG. 22b, which is a graph of compressive load in kN vs. time in seconds, shows the test protocol for the cyclic compressive loading with 0.5 Hz frequency.

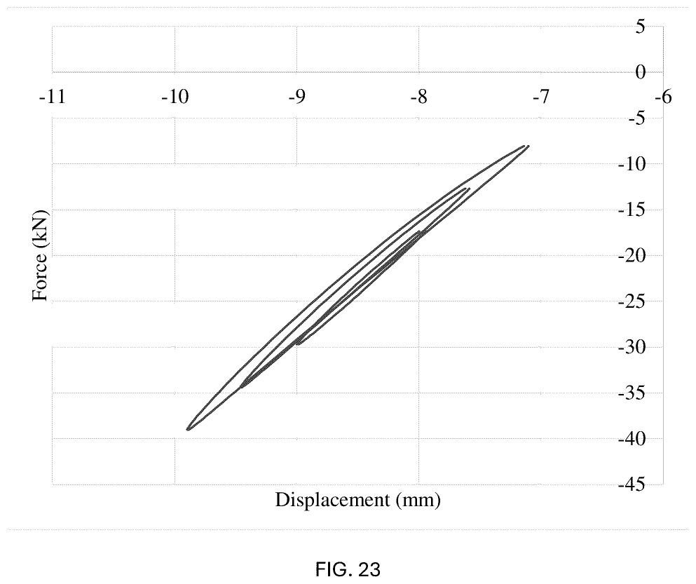

FIG. 23 is a graph of force in kN vs. displacement in mm showing force-deformation behavior of the FCEIs of FIG. 21 under only compression load. It is observed that there is minimal variation in the force-deformation behavior with the change in loading frequency, therefore the results shown here are from the tests with only one loading frequency, 0.5 Hz. Further, all the three isolator samples have resulted in similar force-deformation behavior, thus the average values from the test of the three different isolators are shown in FIG. 23. It must be noted that FIG. 23 only shows the cyclic compression behavior of the FCEIs, and does not include the force-deformation behavior under the slow initial ramp load of 23.55 kN.

As observed from FIG. 23, the vertical compression behavior of FCEIs is much more flexible than conventional layered elastomeric isolators. This is of significant importance as this quality provides the vibration isolation to the structures against the vertical ground motions as well. Table 1 presents the effective compressive stiffness of the prototype FCEIs under the various levels of vertical pressure. It is observed that there is a slight decrease in the effective stiffness of the FCEIs with the increase in vertical load. However, the reduction in the vertical stiffness is minimal, i.e., about 5%.

TABLE 1
Effective compressive stiffness of prototype FCEIs

| | | | |
|---|---|---|---|
| Vertical | 0.75 ± 0.2 | 0.75 ± 0.35 | 0.75 ± 0.5 |
| pressure (MPa) | | | |
| Vertical | 23.55 ± 6.28 | 23.55 ± 10.99 | 23.55 ± 15.70 |
| load (kN) | | | |
| Effective | 11700 | 11567 | 11074 |
| stiffness (N/mm) | | | |

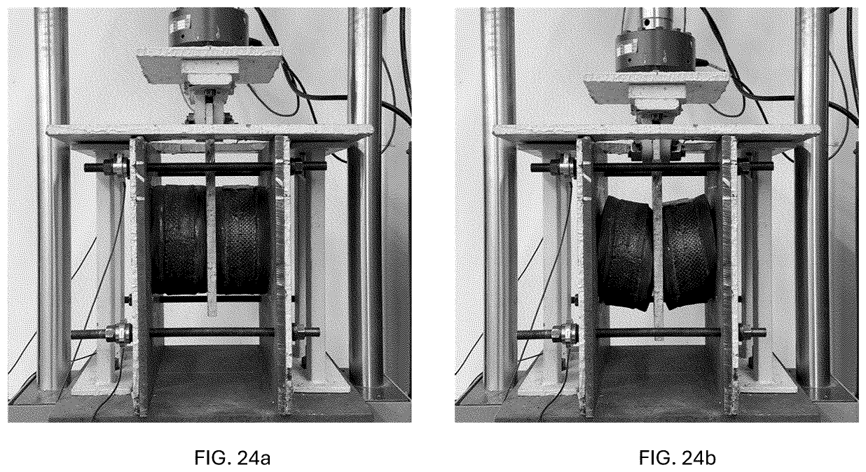

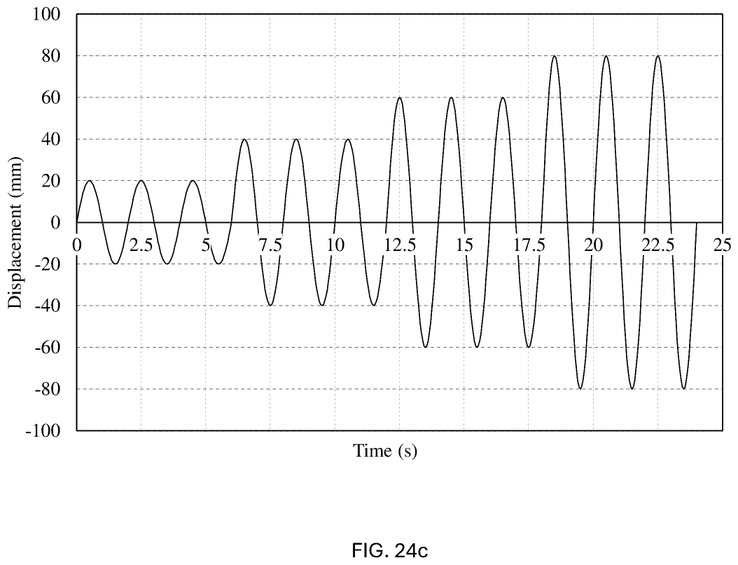

FIGS. 24a and 24b are photographs of a shear test setup (both in undeformed state, FIG. 24a, and deformed state, FIG. 24b) for the FCEIs of FIG. 21. In the shear test, the FCEIs are tested in pairs. The side plates provide the compressive force on the FCEIs, whereas the mid plate is connected to the actuator arm, providing the required shear displacement. The shear tests are conducted in displacement-controlled mode. Four amplitudes of displacement are selected: 20 mm, 40 mm, 60 mm, and 80 mm, with three cycles each. Herein, the frequency of loading is considered as 0.05 Hz, 0.1 Hz, 0.2 Hz, 0.5 Hz, and 0.75 Hz. FIG. 24c, which is a graph of displacement in mm vs. time in seconds shows the test protocol for the cyclic shear loading with 0.5 Hz frequency. The total compressive load on the FCEIs is measured using load cells attached to the threaded rods which keep the side plates in place and maintain the constant compressive load on the isolators. On average, 1.38 MPa compressive pressure is applied to the FCEIs. As the three prototype FCEIs are tested in pairs, resulting in three sets of tests for each loading protocol.

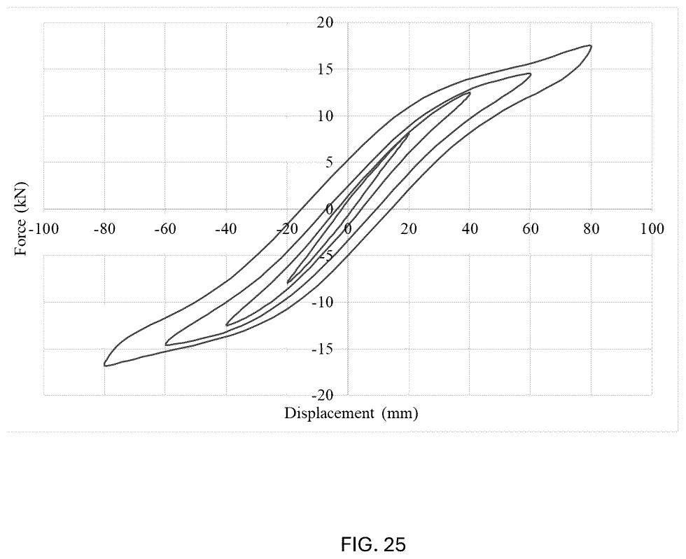

FIG. 25 is a graph of force in kN vs. displacement in mm for force-deformation behavior of prototype FCEIs of FIG. 21 under constant compression and cyclic shear loads. The graph shows the force-deformation of a single FCEI which is the average over all the tests on different FCEIs, under 0.5 Hz of frequency. Here too, there is no significant variation in the force-deformation behavior of the FCEIs with the change in loading frequencies. The FCEIs show good flexible behavior under the shear displacement, because of its unbonded nature. Table 2 presents the effective shear stiffness of the prototype FCEIs under various horizontal displacements. It is observed that the effective stiffness of the FCEIs reduce drastically with the increase in the shear deformation, thus making is even more flexible in nature. Interestingly, towards the 80 mm mark, the shear force exerted by the FCEIs starts to rise again. This is due to the fiber fabric confinement utilized in the FCEI, which provides resistance at larger shear deformations.

TABLE 2
Effective shear stiffness of prototype FCEIs

| | | | | |
|---|---|---|---|---|
| Horizontal | 20 | 40 | 60 | 80 |
| deformation (mm) | | | | |
| Effective | 401.8 | 312.1 | 243.3 | 214.9 |
| stiffness (N/mm) | | | | |

It should be noted that the above provided ranges for K_{eff-comp} and K_{eff-shear} are based on requirements for the isolators based on compressive forces and shear forces experienced by a structure coupled and supported by these isolators. Essentially, the isolators are required to be designed for the specific structure depending on the size of the structure, type of soil/bedrock upon which the structure is built, the geolocation of these structures (i.e., type of historic seismic activity in the area), and the target performance of the seismically isolated structure (i.e., the structure supported on the isolators).

Those having ordinary skill in the art will recognize that numerous modifications can be made to the specific implementations described above. The implementations should not be limited to the particular limitations described. Other implementations may be possible.

1. An elastomer system, comprising:
a block of elastomer; and
one or more bands of fibrous material circumferentially coupled to the block of elastomer along an axial direction,
wherein each of the one or more bands includes one or more layers of fibrous material adhesively attached to the block of elastomer or to other layers of the one or more layers of fibrous material by an adhesive.

2. The elastomer system of claim 1, wherein the block of elastomer is made of one or more of natural rubber, neoprene, ethylene-propylene rubber, nitrite rubber, halogenated butyl rubber, isoprene rubber, styrene-butadiene rubber, butadiene rubber, acrylic rubber, or polyurethane rubber; the fibrous material is made of one or more of carbon fiber fabric, basalt fiber fabric, glass fiber fabric, or steel fiber fabric; and the adhesive is made from cyanoacrylate or epoxy.

3. The elastomer system of claim 1, wherein the block of elastomer, when formed in a cubical shape without the one or more bands, has an effective compressive stiffness (K_{eff-comp}), defined as (maximum compressive force-minimum compressive force)/(maximum compressive displacement-minimum compressive displacement) of between about 500 N/mm to about 100000 N/mm.

4. The elastomer system of claim 1, wherein the block of elastomer, when formed in a cubical shape without the one or more bands, has an effective shear stiffness (K_{eff-shear}), defined as (maximum shear force-minimum shear force)/(maximum shear displacement-minimum shear displacement) of between about 10 N/mm to about 30000 N/mm.

5. The elastomer system of claim 1, wherein the block of elastomer, when formed in a cubical shape having a width, length, and a height with one centrally disposed band having one layer and having a band thickness of about 0.55% of the cube width and a band height of about 50% the cube height, has an effective compressive stiffness (K_{eff-comp}), defined as (maximum compressive force-minimum compressive force)/(maximum compressive displacement-minimum compressive displacement) between about 500 N/mm to about 100000 N/mm.

6. The elastomer system of claim 1, wherein the block of elastomer, when formed in a cubical shape having a width, length, and a height with one centrally disposed band having one layer and having a band thickness of about 0.55% of the cube width and a band height of about 50% the cube height, has an effective shear stiffness (K_{eff-shear}), defined as (maximum shear force-minimum shear force)/(maximum shear displacement-minimum shear displacement) between about 10 N/mm to about 30000 N/mm.

7. The elastomer system of claim 1, wherein the block of elastomer, when formed in a cubical shape having a width, length, and a height with three centrally disposed bands each band having one layer and each band having a band thickness of about 0.55% of the cube width and a band height of about 20% the cube height, has an effective compressive stiffness (K_{eff-comp}), defined as (maximum compressive force-minimum compressive force)/(maximum compressive displacement-minimum compressive displacement) between about 500 N/mm to about 100000 N/mm.

8. The elastomer system of claim 1, wherein the block of elastomer, when formed in a cubical shape having a width, length, and a height with three centrally disposed bands each band having one layer and each band having a band thickness of about 0.55% of the cube width and a band height of about 20% the cube height, has an effective shear stiffness (Keff-shear), defined as (maximum shear force-minimum shear force)/(maximum shear displacement-minimum shear displacement) between about 10 N/mm to about 30000 N/mm.

9. The elastomer system of claim 1, wherein the block of elastomer, when formed in a cubical shape having a width, length, and a height with three centrally disposed bands each band having two layers and each band having a band thickness of about 0.55% of the cube width and a band height of about 20% the cube height, has an effective compressive stiffness (K_{eff-comp}), defined as (maximum compressive force-minimum compressive force)/(maximum compressive displacement-minimum compressive displacement) between about 500 N/mm to about 100000 N/mm.

10. The elastomer system of claim 1, wherein the block of elastomer, when formed in a cubical shape having a width, length, and a height with three centrally disposed bands each band having two layers and each band having a band thickness of about 0.55% of the cube width and a band height of about 20% the cube height, has an effective shear stiffness (K_{eff-shear}), defined as (maximum shear force-minimum shear force)/(maximum shear displacement-minimum shear displacement) between about 10 N/mm to about 30000 N/mm.

11. An anti-seismic isolation elastomer system, comprising:
a plurality of isolation blocks, each isolation block, comprising:
a block of elastomer; and
one or more bands of fibrous material circumferentially coupled to the block of elastomer along an axial direction,
wherein each of the one or more bands includes one or more layers of fibrous material adhesively attached to the block of elastomer or to other layers of the one or more layers of fibrous material by an adhesive.

12. The anti-seismic isolation elastomer system of claim 11, wherein the block of elastomer is made of one or more of natural rubber, neoprene, ethylene-propylene rubber, nitrite rubber, halogenated butyl rubber, isoprene rubber, styrene-butadiene rubber, butadiene rubber, acrylic rubber, or polyurethane rubber; the fibrous material is made of one or more of carbon fiber fabric, basalt fiber fabric, glass fiber fabric, or steel fiber fabric; and the adhesive is made from cyanoacrylate or epoxy.

13. The anti-seismic isolation elastomer system of claim 11, wherein the block of elastomer, when formed in a cubical shape without the one or more bands, has an effective compressive stiffness (_{Keff-comp}), defined as (maximum compressive force-minimum compressive force)/(maximum compressive displacement-minimum compressive displacement) of between about 500 N/mm to about 100000 N/mm.

14. The anti-seismic isolation elastomer system of claim 11, wherein the block of elastomer, when formed in a cubical shape without the one or more bands, has an effective shear stiffness (K_{eff-shear}), defined as (maximum shear force-minimum shear force)/(maximum shear displacement-minimum shear displacement) of between about 10 N/mm to about 30000 N/mm.

15. The anti-seismic isolation elastomer system of claim 11, wherein the block of elastomer, when formed in a cubical shape having a width, length, and a height with one centrally disposed band having one layer and having a band thickness of about 0.55% of the cube width and a band height of about 50% the cube height, has an effective compressive stiffness (K_{eff-comp}), defined as (maximum compressive force-minimum compressive force)/(maximum compressive displacement-minimum compressive displacement) between about 500 N/mm to about 100000 N/mm.

16. The anti-seismic isolation elastomer system of claim 11, wherein the block of elastomer, when formed in a cubical shape having a width, length, and a height with one centrally disposed band having one layer and having a band thickness of about 0.55% of the cube width and a band height of about 50% the cube height, has an effective shear stiffness (K_{eff-shear}), defined as (maximum shear force-minimum shear force)/(maximum shear displacement-minimum shear displacement) between about 10 N/mm to about 30000 N/mm.

17. The anti-seismic isolation elastomer system of claim 11, wherein the block of elastomer, when formed in a cubical shape having a width, length, and a height with three centrally disposed bands each band having one layer and each band having a band thickness of about 0.55% of the cube width and a band height of about 20% the cube height, has an effective compressive stiffness (K_{eff-comp}), defined as (maximum compressive force-minimum compressive force)/(maximum compressive displacement-minimum compressive displacement) between about 500 N/mm to about 100000 N/mm.

18. The anti-seismic isolation elastomer system of claim 11, wherein the block of elastomer, when formed in a cubical shape having a width, length, and a height with three centrally disposed bands each band having one layer and each band having a band thickness of about 0.55% of the cube width and a band height of about 20% the cube height, has an effective shear stiffness (K_{eff-shear}), defined as (maximum shear force-minimum shear force)/(maximum shear displacement-minimum shear displacement) between about 10 N/mm to about 30000 N/mm.

19. The anti-seismic isolation elastomer system of claim 11, wherein the block of elastomer, when formed in a cubical shape having a width, length, and a height with three centrally disposed bands each band having two layers and each band having a band thickness of about 0.55% of the cube width and a band height of about 20% the cube height, has an effective compressive stiffness (K_{eff-comp}), defined as (maximum compressive force-minimum compressive force)/(maximum compressive displacement-minimum compressive displacement) between about 500 N/mm to about 100000 N/mm.

20. The anti-seismic isolation elastomer system of claim 11, wherein the block of elastomer, when formed in a cubical shape having a width, length, and a height with three centrally disposed bands each band having two layers and each band having a band thickness of about 0.55% of the cube width and a band height of about 20% the cube height, has an effective shear stiffness (K_{eff-shear}), defined as (maximum shear force-minimum shear force)/(maximum shear displacement-minimum shear displacement) between about 10 N/mm to about 30000 N/mm.
